(19) United States
(12) Patent Application Publication
(10) Pub. No.: US 2024/0392889 A1
(43) Pub. Date: Nov. 28, 2024

(54) System For Monitoring The Position Of A Valve Body In A Value Unit And A Value Unit For A Coolant Circuit Of An At Least Partially Electrically Driven

(71) Applicant: ECO Holding 1 GmbH, Marktheidenfeld (DE)

(72) Inventors: Renè Heym, Osfildern/Kemnat (DE); Georg Weisser, Rottenburg (DE)

(73) Assignee: ECO Holding 1 GmbH, Marktheidenfeld (DE)

(21) Appl. No.: 18/672,253

(22) Filed: May 23, 2024

(30) Foreign Application Priority Data
May 24, 2023 (DE) DE 102023113593.7

(51) Int. Cl. F16K 37/00; F16K 27/02

(52) U.S. Cl. CPC F16K 37/0033; F16K 27/02

(57) ABSTRACT

A system for monitoring the position of a valve body in a valve unit for a coolant circuit of an at least partially electrically powered vehicle includes: a valve housing for accommodating a valve body, wherein the valve body is accommodated in the valve housing between a first position, in which the valve body is arranged in contact with a valve seat and closes the valve unit, and a second position, in which the valve body is spaced from the valve seat and the valve unit is at least partially open, a piston rod for transmitting a drive movement to the valve body, wherein the piston rod includes a recess for accommodating a permanent magnet, and a sensor unit fixedly arranged in relation to the valve seat and designed to detect a position of a permanent magnet accommodated in the recess.

### FIELD OF THE INVENTION

The invention relates to a system for monitoring the position of a valve body in a valve unit for a coolant circuit of an at least partially electrically powered vehicle. Furthermore, the invention relates to a valve unit for a coolant circuit of an at least partially electrically driven vehicle.

### BACKGROUND OF THE INVENTION

Various types of sensors are used in the prior art to monitor the position of valve bodies in valve units. Depending on the specific application, it may be very important to detect the exact position of the valve body. For example, the exact position of the valve body in relation to the valve seat of the valve unit can be used to determine the possible flow rate of a coolant.

Monitoring the position of valve bodies is a safety-relevant aspect, especially in the field of motor vehicles. For example, components such as battery or brake systems are cooled by coolant, which is why the position of valve bodies within such coolant circuits is of great importance. The position of the valve body is therefore relevant for the functionality of safety-relevant components in a motor vehicle. The sensors are preferably accommodated on the drive of the valve unit.

A disadvantage of the prior art is that position measurement on the drive is associated with uncertainties. For example, the transmission of a drive movement of the drive to a valve body may be disturbed or defective. As a consequence, it is no longer possible to determine the actual position of the valve body. This results in major safety risks in the operation of motor vehicles.

### BRIEF SUMMARY OF THE INVENTION

The task of the invention is to propose a system for monitoring the position of a valve body which belongs to the technical field mentioned at the beginning and which at least partially overcomes the disadvantages of the prior art. Furthermore, it is the task of the invention to provide a valve unit for a coolant circuit and a motor vehicle with such a system and/or valve unit.

An embodiment of the invention comprises a system for monitoring the position of a valve body in a valve unit for a coolant circuit of an at least partially electrically driven vehicle. The system comprises a valve housing for accommodating a valve body, wherein the valve body is designed to be transferable in the valve housing between a first position, in which the valve body is arranged in contact with a valve seat and closes the valve unit, and a second position, in which the valve body is spaced apart from the valve seat and the valve unit is at least partially open. The system also comprises a piston rod for transmitting a drive movement to the valve body, with the piston rod comprising a recess for arranging a permanent magnet. In addition, the system comprises a sensor unit which is permanently accommodated in relation to the valve seat and is designed to detect the position of a permanent magnet accommodated in the recess of the piston rod.

This presents the technical advantage, for example, that the position of the valve body is not measured at the actuator. This increases the reliability of the position determination because possible interference or interruptions between the drive and the valve body are eliminated as a source of error. Another advantage is that the magnet is not accommodated directly on the valve body itself, which further improves the quality of the measurement. By arranging the magnet on the piston rod, the measuring accuracy can be increased and the assembly of the valve unit simplified.

### Definitions

A valve housing within the meaning of the present invention is used for the flow of refrigerant through the valve unit, wherein the valve body is arranged in the valve housing and can determine the flow rate of the refrigerant through the valve unit by its position relative to the valve seat. When the valve body is fully seated in the valve seat of the valve housing, the valve housing is closed and no refrigerant can flow through the valve unit. When the valve body is spaced from the valve seat, the valve unit is open to the flow of refrigerant and the extent of the distance between the valve body and the valve seat determines the possible flow rate of fluid through the valve body.

A piston rod in the sense of the present invention is understood as a direct connecting means which transmits an axial drive movement directly to the valve body.

According to a preferred embodiment, the valve body is transferred in the valve housing between a first position and a second position in the direction of a piston rod longitudinal axis L. This achieves the technical advantage, for example, that the movement of an actuator is transferred directly to the valve body. The direct transfer from the piston rod to the valve body enables particularly precise position measurement.

According to a further embodiment, the valve body and the recess are arranged at a distance from each other in the direction of the piston rod longitudinal axis L. This achieves the technical advantage, for example, that the valve body can be designed to be completely flow- and function-optimized. The valve body therefore does not have to include a recess for accommodating a permanent magnet, which greatly simplifies the provision of the valve body. Due to the spacing in the direction of the longitudinal direction of the piston rod, the position detection function of the valve body can be carried out at a distance from the piston rod.

According to a particularly preferred embodiment, a distance between the valve body and the recess in the direction of the piston rod longitudinal axis L is greater than a diameter of the valve body.

According to a further embodiment, the recess is radially spaced with respect to a piston rod longitudinal axis L and is arranged facing a side wall of the valve housing.

An important factor for the quality and accuracy of the signal output by the sensor is that the magnetic field strength is sufficiently high to hit the operating range of the sensor. This can be realized in particular by keeping the so-called air gap as small as possible and constant between a first position and a second position during the transfer of the valve body in the direction of the piston rod longitudinal axis L. The air gap thus corresponds to the geometric distance between the detecting sensor unit and the permanent magnet.

By arranging the recess for accommodating the permanent magnet facing the side wall of the valve housing, the air gap and the dimensions of the permanent magnet can be minimized. Overall, this can reduce manufacturing costs and improve the function of the system.

According to a particularly preferred embodiment, the recess comprises a latching mechanism for fixing a permanent magnet. This can, for example, achieve the technical advantage that the assembly of the system and the installation of the system in a valve unit can be carried out particularly efficiently and without assembly errors. The permanent magnet is configured to only be mounted in a very specific way, which is predetermined by the latching mechanism.

To further simplify the assembly of the permanent magnet, the latching mechanism comprises a first clamping arm and a second clamping arm for gripping around a permanent magnet. The permanent magnet is clamped in position by the first clamping arm and the second clamping arm. The clamping arms are arranged symmetrically to each other, whereby the position of the permanent magnet is precisely fixed in the middle between the clamping arms.

According to an additional embodiment, the valve housing comprises a bearing element for axially guiding the piston rod when transferring between a first position and a second position. This achieves the technical advantage, for example, that the piston rod is guided with particular precision. The precise guidance of the piston rod additionally improves the position measurement of the permanent magnet and thus of the valve body.

According to another preferred embodiment, the system comprises an anti-rotation device to prevent the piston rod from rotating relative to the valve housing. This achieves, for example, the technical advantage that the precision of the position detection of the permanent magnet is additionally improved. As already mentioned, it is important for the quality and accuracy of the signal output by the sensor that the magnetic field strength is sufficiently high to hit the sensor. For this purpose, the air gap should be as small as possible and should remain constant between a first position and a second position during the transfer of the valve body in the direction of the piston rod longitudinal axis L. The anti-rotation device prevents the piston rod from rotating relative to the valve housing. As a result, it is no longer necessary to use a large, specifically adapted magnetic ring, which on the one hand would require fluidic openings and on the other would cause high costs. In combination with the bearing element, the air gap and the dimensions of the permanent magnet are also minimized. The expensive magnetic material can be reduced to a minimum with high precision in position detection.

In order to additionally minimize the air gap and to further improve position detection, the anti-rotation device comprises a guide means for guiding the recess when transferring the valve body between a first position and a second position.

According to a particularly preferred embodiment, the first clamping arm and the second clamping arm are designed to slide on the guide means when transferring the valve body between a first position and a second position.

In order to additionally improve the guidance of the bearing element, the guide means comprises a first guide arm and a second guide arm, with the first guide arm and the second guide arm axially guiding the recess. This achieves the technical advantage, for example, that the guide means has a dual function. On the one hand, the guide means serves as an anti-rotation device. On the other hand, the guide means supports the bearing of the recess and thus the axial bearing of the piston rod. Overall, this results in a highly precise position detection of the permanent magnet, whereby the assembly of the system is particularly simple and error-free.

According to an alternative embodiment, the anti-rotation device is arranged on the bearing element, whereby the piston rod is designed to be non-rotatable in relation to the bearing element. This embodiment also presents the technical advantage, for example, that the piston rod is guided with particular precision. The precise guidance of the piston rod additionally improves the position measurement of the permanent magnet and thus of the valve body.

According to a particularly preferred embodiment, the sensor unit comprises a Hall sensor.

In order to make installation and maintenance of the valve unit particularly easy, the valve housing comprises a housing for accommodating the sensor unit and control electronics for the system, with the housing being arranged directly adjacent to the side wall of the valve housing.

For example, the entire electronics of the valve unit can be arranged in the housing. In this way, the components of the electronics are housed in an easily accessible location and are not distributed throughout the valve unit. This reduces the manufacturing costs and the assembly effort of the system and the valve unit.

According to a further aspect, the problem of the invention is solved by a valve unit for a coolant circuit of an at least partially electrically driven vehicle, with a system according to one of the above embodiments.

The advantages are essentially comparable to those of the above embodiments. In particular, for example, the technical advantage is achieved that the position of the valve body within the valve unit is not measured at the drive. This increases the reliability of the position determination because possible interference or interruptions between the drive and the valve body are eliminated as a source of error. Another advantage is that the magnet is not arranged directly on the valve body itself, which further improves the quality of the measurement. By arranging the magnet on the piston rod, the measuring accuracy can be increased and the assembly of the valve unit can be simplified.

According to a particularly advantageous embodiment, the valve unit comprises a control valve or a changeover valve. A further subsidiary aspect of the invention relates to a vehicle, in particular a motor vehicle, with a system and/or a valve unit according to one of the preceding embodiments. The advantages are essentially comparable to those of the preceding embodiments.

Further advantageous embodiments and combinations of features of the invention result from the following detailed description and the entirety of the patent claims.

### BRIEF DESCRIPTION OF THE DRAWINGS

The different and exemplary features described above can be combined with one another in accordance with the invention, insofar as this is technically expedient and suitable. Further features, advantages and embodiments of the invention are shown in the following description of the embodiments illustrated in the figures. The figures show

FIG. 1A perspective sectional view of an embodiment of a system according to an embodiment of the invention;

FIG. 2A sectional view of a part of a system according to an embodiment of the invention;

FIG. 3A, B, C A perspective view of a recess including a permanent magnet;

FIG. 4A A further perspective sectional view of an embodiment of a system according to the invention;

FIG. 4B A cross-sectional view of an embodiment of a system according to an embodiment of the invention;

FIG. 5A A perspective view of a recess and an anti-rotation device of an embodiment of a system according to the invention; and

FIG. 5B A cross-sectional view of an embodiment of an anti-rotation device of the system according to an embodiment of the invention.

In principle, identical parts are marked with identical reference signs in the figures.

### DETAILED DESCRIPTION

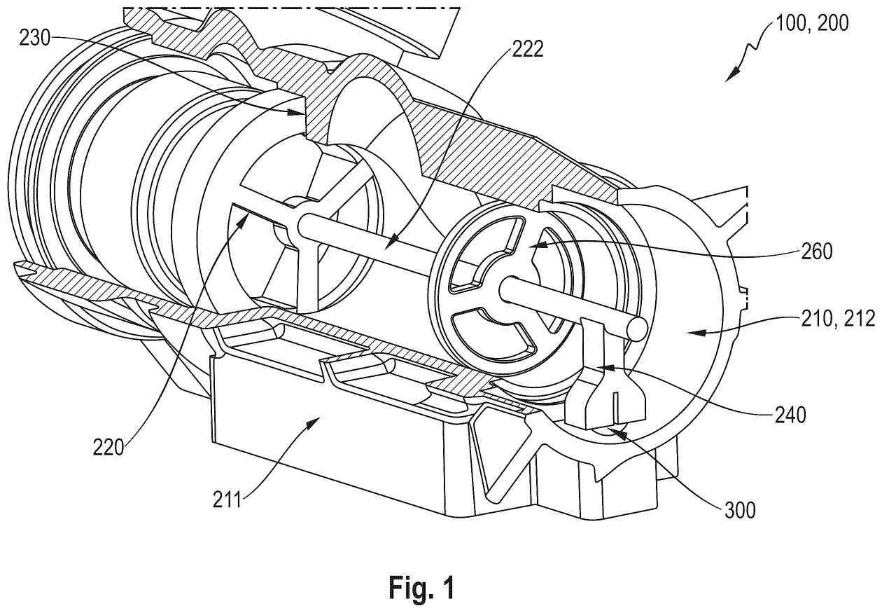

FIG. 1 shows a perspective sectional view of an embodiment of a system 100 according to the invention for monitoring the position of a valve body 220 in a valve unit 200 for a coolant circuit of an at least partially electrically driven vehicle.

The system 100 comprises a valve housing 210 for accommodating a valve body 220. The valve body 220 is used to regulate a coolant flow, wherein the valve body 220 is configured to be transferred between a position in contact with the valve seat 230, in which the valve body 220 closes off the coolant flow through the valve housing 210, and an open position, in which the valve body 220 is spaced apart from the valve seat 230 and thus allows a coolant flow through the valve housing 210. Depending on the distance between the valve seat 230 and the valve body 220, the volumetric flow rate of the coolant can be controlled. The valve body 220 is actuated by an actuator, the movement of the actuator being transmitted to the valve body 220 by means of a piston rod 222.

In addition, the piston rod 222 comprises a recess 240, which is designed to accommodate a permanent magnet 300. Thus, the piston rod 222 serves on the one hand as an actuating element of a linear actuator and on the other hand as a holder for a permanent magnet 300. The permanent magnet 300 can now be used by means of a housing-integrated sensor unit 250 (not shown) for position feedback of the piston rod 222. Thus, the housing-integrated sensor unit 250 is fixed with respect to the valve seat 230 and is configured to detect the position of a permanent magnet 300 disposed in the recess 240. Due to the linear drive and the transmission of the drive movement via the piston rod 222 to the valve body 220, the piston rod 222 and the valve body 220 move in the direction of a piston rod longitudinal axis L.

The recess 240 is spaced from the valve body in the direction of the piston rod longitudinal axis L in order to make the position detection of the permanent magnet 300 as independent as possible of fluid turbulence and pressure differences. In addition, the precision of the position detection is improved by the recess 240 facing radially from the piston rod longitudinal axis L towards the side wall 212 of the valve housing 210. This arrangement particularly improves the use of position measurement with a permanent magnet 300 and a sensor unit 250 in the form of a Hall sensor. The Hall sensor is configured to detect the change in the magnetic field through its current-carrying Hall elements and thus report back the current position by means of an electrical signal. This requires a strong external magnetic field, which is provided by the permanent magnet 300. The permanent magnet 300 is firmly connected to the piston rod 222. The field strength of the permanent magnet 300 is decisive for the quality and accuracy of the sensor-side signal in order to hit the working range of the Hall sensor. The geometric distance between the detecting sensor unit 250 in the form of the Hall sensor and the permanent magnet 300 is decisive for this function. It is therefore advantageous in terms of design to realize the smallest possible geometric distance, because this also allows the dimensions of the permanent magnet 300 to be reduced. This saves weight and manufacturing costs.

Between the valve body 220 and the recess 240, the piston rod 222 is guided by a bearing element 260. The bearing element 260 additionally supports the accuracy of the position detection. The bearing element 260 is located in the flow channel of the valve housing 210 and comprises openings that allow the refrigerant to flow through the valve housing 210.

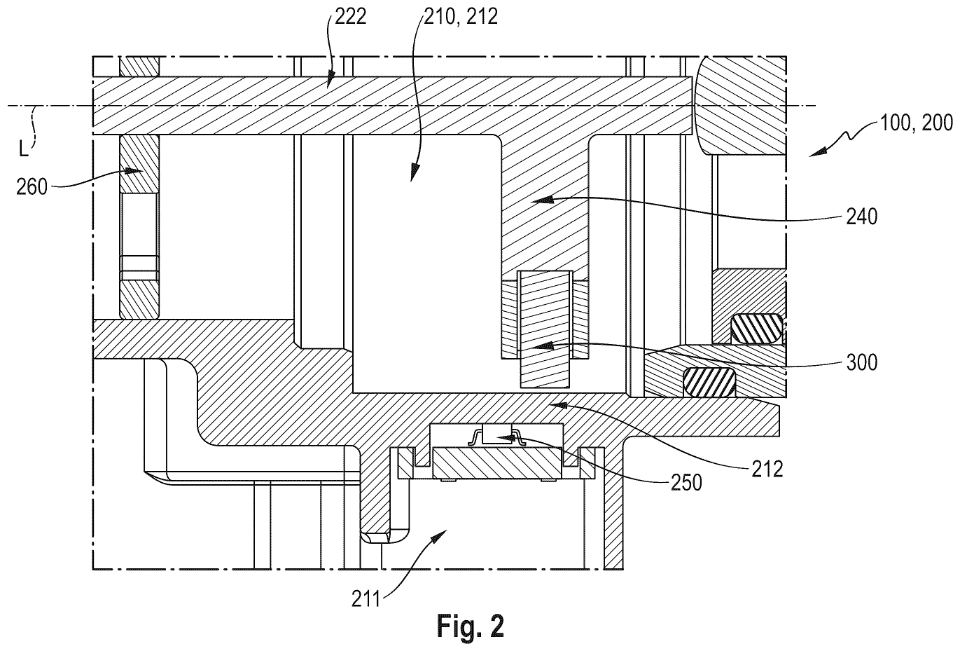

FIG. 2 shows a sectional view of a part of the system 100 according to the invention, showing the piston rod 222 with the recess 240, wherein a permanent magnet 300 is arranged at the recess 240. The piston rod 222 is arranged in the valve housing 210 along the piston rod longitudinal axis L and is guided by the bearing element 260. The valve housing 210 comprises a further housing 211, which is configured for accommodating the sensor unit 250 and other electronic components of the valve unit 200. The housing 211 is preferably separated from the valve housing 210 and accessible via a separate opening; for example, the entire electronics such as a control unit and other electronic components are configured to be accommodated in the housing 211. Preferably, the housing 211 is hermetically sealed, whereby separation from cooling water and the environment would be realized. This results in further advantages such as cooling of the electronic components by passing refrigerant in the valve housing 210 and precise position detection of the permanent magnet 300 through the side wall 212 between the housing 211 and the valve housing 210 by means of the sensor unit 250 in the form of a Hall sensor.

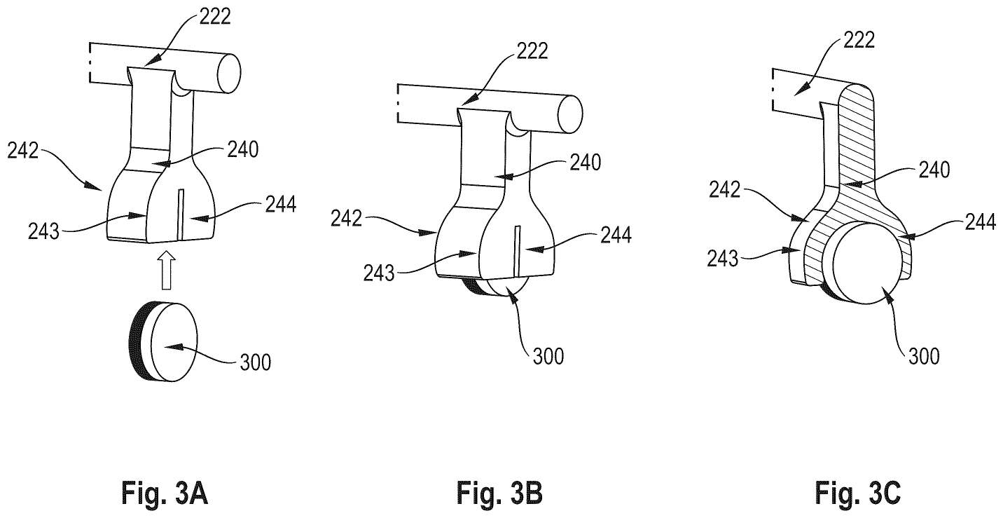

FIGS. 3A to 3C each show a perspective view of a recess 240 including a permanent magnet 300.

The recess 240 comprises a latching mechanism 242 for accommodating a permanent magnet 300. The latching mechanism 242 comprises two clamping arms 243, 244 arranged in parallel, which comprise a space between them for accommodating a permanent magnet 300. Here, the first clamping arm 243 and the second clamping arm 244 are designed to grip around a permanent magnet 300, with the clamping arms 243, 244 clamping the permanent magnet 300 by an elastic restoring force and thus forming the latching mechanism 242.

FIG. 3A shows the permanent magnet 300 outside the recess 240, with the directional arrow indicating the direction of insertion of the permanent magnet 300 into the recess 240.

FIG. 3B shows the permanent magnet 300 in the recess 240. The latching mechanism 242 has gripped the permanent magnet 300 with the first clamping arm 243 and the second clamping arm 244, and the permanent magnet 300 is in a fixed state in the recess 240.

FIG. 3C shows a cross-sectional view of the permanent magnet 300 in the recess 240.

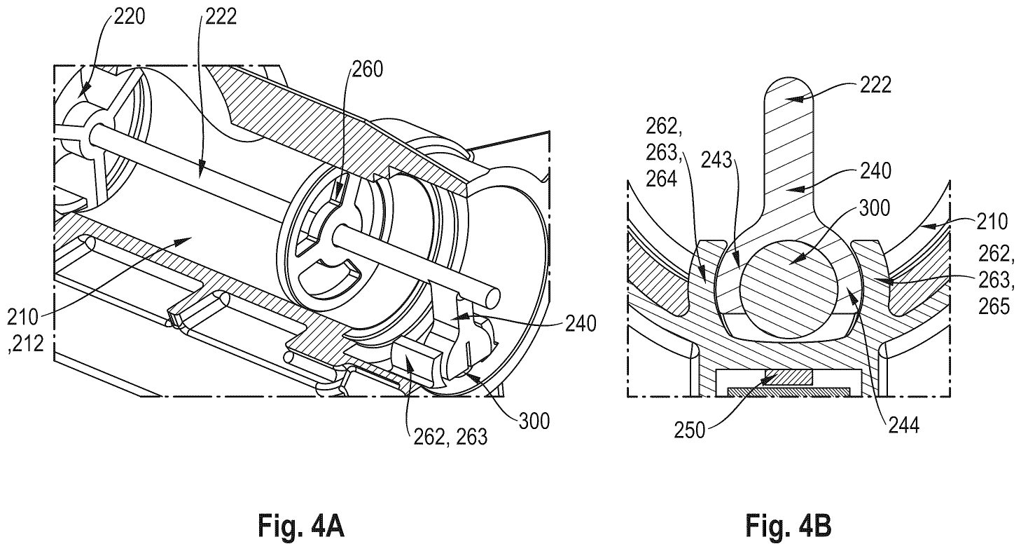

FIG. 4A shows a further perspective sectional view of an embodiment of a system 100 according to the invention. The illustration again shows the piston rod 222 with the recess 240 and the valve body 220, wherein a permanent magnet 300 is arranged at the recess 240. The piston rod 222 is arranged in the valve housing 210 and is guided by the bearing element 260. In addition, the system 100 comprises an anti-rotation device 262 which blocks rotation of the piston rod 222 relative to the valve housing 210. The anti-rotation device 262 comprises a guide means 263 in the form of two guide arms 264, 265 (not shown) arranged in parallel on the side wall 212 of the valve housing 210. The guide means 263 blocks the rotation of the piston rod 222 relative to the valve housing 210 but guides the recess 240—including a permanent magnet 300 arranged in the recess—when transferring the valve body 220 in the direction of the piston rod longitudinal axis L between a first position and a second position. Here, the first clamping arm 243 and the second clamping arm 244 of the recess 240 slide between the guide arms 264, 265 arranged on the side wall 212 of the valve housing 210 in the direction of the piston rod longitudinal axis L.

FIG. 4B shows a cross-sectional view of an embodiment of a system 100 according to the invention, showing the anti-rotation device 262 which blocks rotation of the piston rod 222 relative to the valve housing 210. The anti-rotation device 262 comprises the guide means 263 with the first guide arm 264 and the second guide arm 265. The guide means 263 guides the recess 240 with the permanent magnet 300 in the direction of the piston rod longitudinal axis L. The first guide arm 264 and the second guide arm 265 embrace the recess 240 like a clamp, so that the recess 240 must be clipped between the first guide arm 264 and the second guide arm 265. As a result, the recess 240 is additionally guided in the piston rod longitudinal axis L, which additionally improves the quality of the position detection of the permanent magnet 300 and thus of the valve body 220.

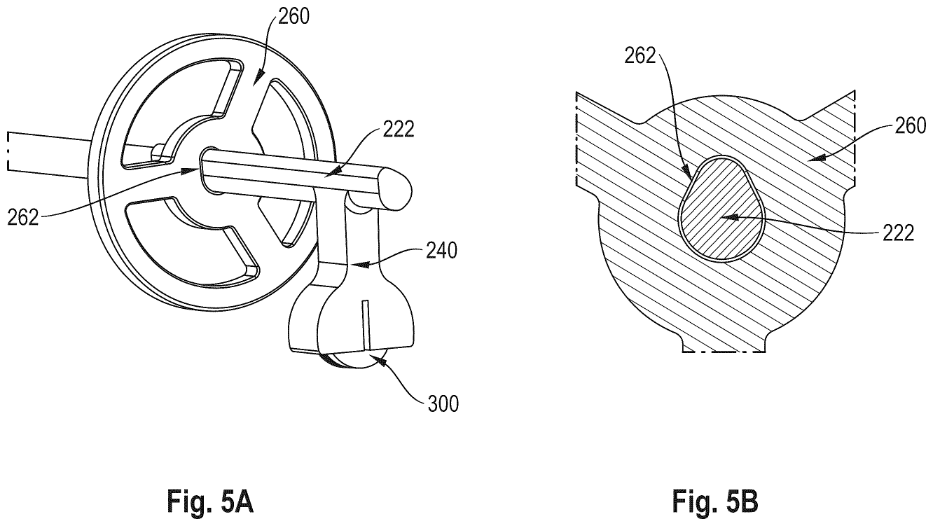

FIG. 5A shows a perspective view of a recess 240 and an anti-rotation device 262 of an embodiment of a system 100 according to the invention.

The illustration shows the piston rod 222 with the recess 240, wherein a permanent magnet 300 is arranged at the recess 240. The piston rod 222 is guided in the direction of the piston rod longitudinal axis L via a bearing element 260. In addition to guiding the piston rod 222 in the direction of the piston rod longitudinal axis L, the anti-rotation device 262 blocks rotation of the piston rod 222 relative to the valve housing 210 (not shown). This anti-rotation device 262 is realized in that the piston rod 222 is designed to be non-rotatable in relation to the bearing element 260. In this case, the cross-section of the piston rod 222 is not rotationally symmetrical, with the guide opening of the bearing element 260 being adapted to the non-rotationally symmetrical cross-sectional shape.

FIG. 5B shows a cross-sectional view of an embodiment of an anti-rotation device 262 of the system 100 according to the invention. The cross-section of the piston rod 222 is not rotationally symmetrical. In the present embodiment, the cross-section of the piston rod 222 is oval. Alternatively, however, the cross-section could be triangular, square or any other cross-sectional shape that prevents rotation between the piston rod 222 and the bearing element 260.

### LIST OF REFERENCES

| | |
|---|---|
| 100 | System |
| 200 | Valve unit |
| 210 | Valve housing |
| 211 | Housing |
| 212 | side wall |
| 220 | Valve body |
| 222 | Piston rod |
| 230 | Valve seat |
| 240 | Recess |
| 250 | sensor unit |
| 260 | Bearing element |
| 262 | Anti-rotation device |
| 263 | Guide means |
| 264 | First guide arm |
| 265 | Second guide arm |
| 300 | Permanent magnet |
| L | Piston rod longitudinal axis |

What is claimed is:

1. A system for monitoring a position of a valve body in a valve unit for a coolant circuit of an at least partially electrically powered vehicle, the system comprising:
a valve housing for accommodating a valve body, wherein the valve body is configured to be transferable in the valve housing between a first position, in which the valve body is arranged in contact with a valve seat and closes the valve unit, and a second position, in which the valve body is spaced apart from the valve seat and the valve unit is at least partially open,
a piston rod for transmitting a drive movement to the valve body, wherein the piston rod comprises a recess for accommodating a permanent magnet, and
a sensor unit arranged fixedly in relation to the valve seat and configured to detect a position of a permanent magnet accommodated in the recess of the piston rod.

2. The system according to claim 1, wherein the transfer of the valve body in the valve housing between a first position and a second position takes place in the direction of a piston rod longitudinal axis (L).

3. The system according to claim 1, wherein the valve body and the recess are arranged spaced apart from each other in the direction of the piston rod longitudinal axis (L).

4. The system according to claim 3, wherein a distance between the valve body and the recess in the direction of the piston rod longitudinal axis (L) is greater than a diameter of the valve body.

5. The system according to claim 1, wherein the recess is arranged radially spaced with respect to a piston rod longitudinal axis (L) and facing a side wall of the valve housing.

6. The system according to claim 1, wherein the recess comprises a latching mechanism for fixing a permanent magnet.

7. The system according to claim 6, wherein the latching mechanism comprises a first clamping arm and a second clamping arm for gripping around a permanent magnet.

8. The system according to claim 1, wherein the valve housing comprises a bearing element for axially guiding the piston rod when transferring between a first position and a second position.

9. The system according to claim 1, further comprising an anti-rotation device for preventing rotation of the piston rod relative to the valve housing.

10. The system according to claim 9, wherein the anti-rotation device comprises a guide means for guiding the recess when transferring the valve body between a first position and a second position.

11. The system according to claim 10, wherein the latching mechanism comprises a first clamping arm and a second clamping arm for gripping around a permanent magnet, and
wherein the first clamping arm and the second clamping arm are configured to slide on the guide means when transferring the valve body between a first position and a second position.

12. The system according to claim 11, wherein the guide means comprises a first guide arm and a second guide arm, wherein the first guide arm and the second guide arm axially guide the recess.

13. The system according to claim 9, wherein the anti-rotation device is arranged on the bearing element, wherein the piston rod is configured to be non-rotatable in relation to the bearing element.

14. The system according to claim 1, wherein the sensor unit comprises a Hall sensor.

15. The system according to claim 1, wherein the valve housing comprises a housing for the recess of the sensor unit and a control electronics for the system, wherein the housing is arranged directly adjacent to a side wall of the valve housing.

16. A valve unit for a coolant circuit of an at least partially electrically driven vehicle, comprising a system according to claim 1.

17. The valve unit according to claim 15, further comprising a control valve or a changeover valve.

18. A vehicle comprising a system according to claim 1.
